(19) United States
(12) Patent Application Publication
(10) Pub. No.: US 2013/0203035 A1
(43) Pub. Date: Aug. 8, 2013

(54) LEARNING SUPPORT SYSTEM AND METHOD

(71) Applicant: CONNECT LINK USA CORP., Sunnyvale, CA (US)

(72) Inventor: Akira MURAMATSU, Kanagawa (JP)

(73) Assignee: CONNECT LINK USA CORP., Sunnyvale, CA (US)

(21) Appl. No.: 13/752,525

(22) Filed: Jan. 29, 2013

Related U.S. Application Data
(60) Provisional application No. 61/594,455, filed on Feb. 3, 2012.

(51) Int. Cl. G09B 3/00

(52) U.S. Cl. CPC G09B 3/00
USPC 434/335

(57) ABSTRACT

The present invention is a learning support system which supports learning on a computer comprising means for reading a question sheet on a computer as an image, means for identifying each problem from the image, means for entering whether correct answer was obtained or not for each problem on the question sheet, and means for identifying components of problems entered as incorrect in the means for entering whether correct answer was obtained or not on a database.

### BACKGROUND OF THE INVENTION

1. Field of the Invention

The present invention relates to systems and methods for supporting learning by identifying components of the problems in user's weak area in the reviewing process of studies on a computer.

2. Description of the Related Art

In recent years, computer-based learning support systems have been popular in educational field along with the remarkable popularization of computers.

As a previous learning support system, learning support server system 1 manages instructional materials (materials related to students' studying such as problems on each subject, answers, and solutions) as data, and learning support server system 1, client system on students' side 2, and client system on teachers' side 3 are connected with each other to communicate via communication line 4 in Japanese Patent Publication Number 2004-157616, for instance. However, it is hard to directly make a connection with paper-based homework and assignments from school in such system that review of homework and assignments might be neglected.

In this regard, Japanese Patent Publication Number 2006-106182 discloses a scoring system of an answer sheet wherein an answer sheet is read by a scanner and scored based on positioning data, answer data, score data, and point allocation data stored in a file folder for required information and answer information entered in an answer sheet. According to this system, information on students' necessity level for review of problems can be gathered and managed that efficient and focused review can be supported for students according to their needs . However, it is inconvenient in the way that it is necessary to save information regarding answer sheets in a data folder beforehand in this system. Thus, it cannot be applied to random homework and assignments not corresponding with the saved information.

Therefore, the object of the present invention is to analyze components of problems in user's weak area by entering whether a correct answer was obtained or not for each problem on an answer sheet read as an image on a computer so that efficient reviewing is supported.

### SUMMARY OF THE INVENTION

The present invention that solves the above problems is a learning support system which supports learning on a computer comprising, means for reading a question sheet on a computer as an image, means for identifying each problem from the image, means for entering whether correct answer was obtained or not for each problem on the question sheet, and means for identifying components of problems entered as incorrect in the means for entering whether correct answer was obtained or not on a database.

According to this system, specific components included in each problem can be identified by recognizing each problem on a question sheet read as an image. In this way, a user can efficiently review and manage the problems in his weak areas which became clear in every-day homework and assignments on a computer in the learning support system of the present invention.

### BRIEF DESCRIPTION OF THE DRAWINGS

For more complete understanding of the present invention and the advantages hereof, reference is now made to the following description taken in conjunction with the accompanying drawings wherein:

FIG. 1 depicts a structure of a learning support system according to an embodiment of the present invention;

FIG. 2 depicts a screen showing a question sheet read on a computer according to an embodiment of the present invention;

FIG. 3 depicts a flowchart of a learning support system according to an embodiment of the present invention; and

FIG. 4 depicts a screen showing a frame of a solution video which contains a typical error according to another embodiment of the present invention.

### DETAILED DESCRIPTION OF THE EXEMPLARY EMBODIMENTS OF THE INVENTION

A description will be given below, of a system according to embodiments of the present invention with reference to the attached drawings.

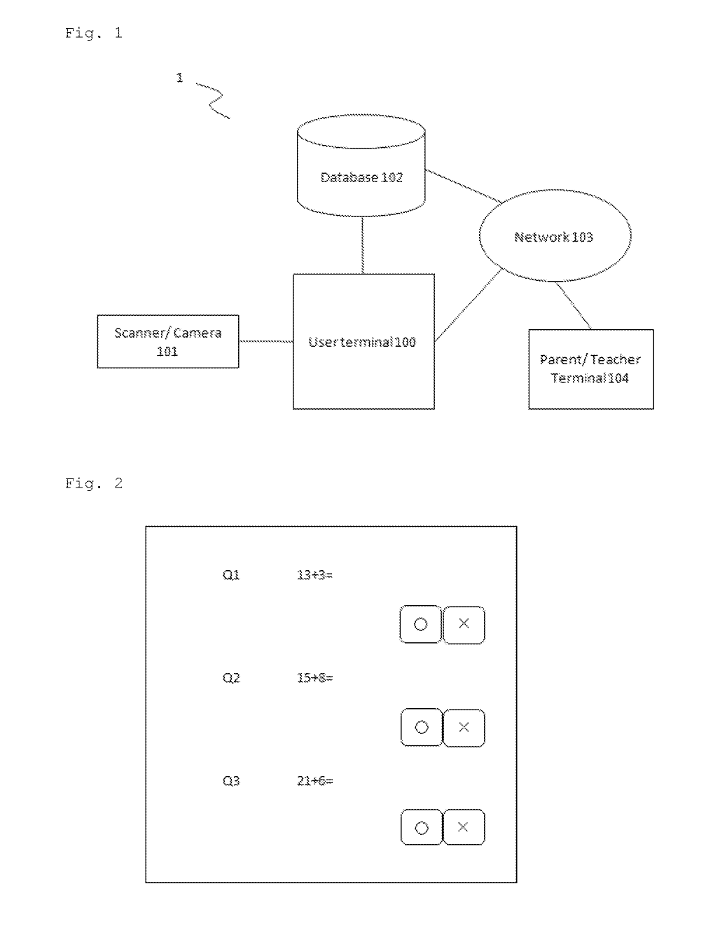

As shown in FIG. 1, learning support system 1 according to an embodiment of the present invention comprises user terminal 100, scanner/camera 101, database 102, network 103, and parent/teacher terminal 104.

FIG. 2 shows a screen showing a question sheet scanned on user terminal 100 according to an embodiment of the present invention. As shown in FIG. 2, each problem is recognized after a question sheet is scanned, and clickable signs indicating correct or incorrect are displayed for each problem on arbitrary position.

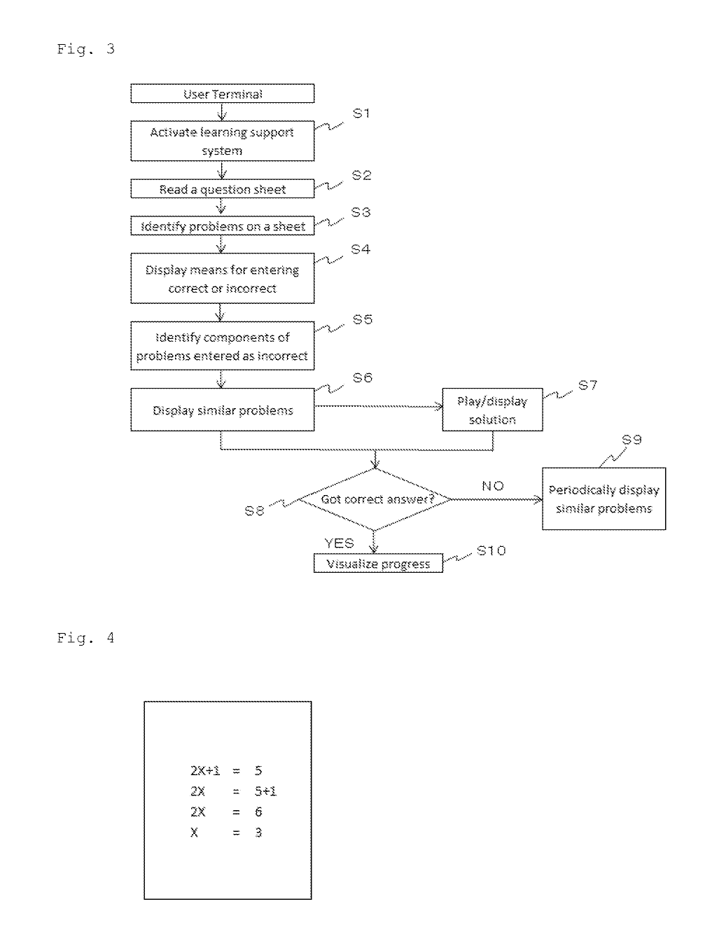

According to the flowchart of learning support system 1 shown in FIG. 3, learning support system 1 is activated on user terminal 100 first, and then a blank question sheet is read using scanner or camera 101. Database 102 identifies each problem on the image of the question sheet and displays means for entering whether the correct answer was obtained or not for each problem. Then, a user enters whether he got a correct answer or not for each problem on a computer referring to the scored question sheet returned from school. After that, database 102 identifies the components of the problems entered as incorrect by a user.

For instance, in addition problems on the question sheet shown in FIG. 2, database 102 presumes that the user has difficulty in problems with increase in digit if the second problem was entered as incorrect, and displays similar problems which contain the same components as the original problem so that the user can solve them on user terminal 100. Even if the components contained in each problem on a question sheet read on user terminal 100 were not supposed at first in database 102 because of complexity, those can be added to database 102 later on as necessary.

When displaying the similar problems on user terminal 100, a user can select to display or play solutions of the problems.

Animation is arbitrarily used so that a user can easily understand and learn with enjoyment. Moreover, group lessons can be held by a grader on network 103 for users who share a weak area.

Furthermore, to gain further understanding on the problems in user's weak area, hands-on learning activities can be provided on the step of displaying problems similar to the problems in user's weak area in another embodiment of the present invention. For instance, database 102 displays a calculation problem that makes user use real money. in this case, the user needs to upload a video or an image of the answer using real money on network 103 so that a grader can evaluate. This embodiment can be applied for many subjects including social science and science, not limited to the above-mentioned mathematical problems.

Corrects and incorrects of the displayed similar problems are recorded in database 102, and user's progress is visualized and displayed if answers are correct. For instance, a puzzle is solved or a step is moved on to the next stage in a game every time a correct answer is gained for each problem. According to such embodiment, user's motivation for learning can be raised.

If answers are incorrect, database 102 records the results and periodically displays similar problems which contain the same components as the problems with incorrect answers when the learning support system 1 of the present invention is used thereafter.

Furthermore, user's learning progress can be sent to parent/teacher terminal 104. As for the terminals, mobile phones, personal computers, car navigations, and etc. are included, but not limited to these items.

In another embodiment of the present invention, database 102 automatically generates a reference solution video based on the components of problems entered as incorrect in the means for entering whether correct answer was obtained or not. In this way, a user can refer how to solve the problems step-by-step soon after database 102 identifies components of problems entered as incorrect by the user.

Moreover, database 102 can also automatically generate a solution video which contains typical errors based on the components of problems entered as incorrect in the means for entering whether correct answer was obtained or not. FIG. 4 shows a screen in a solution video of an equation problem which purposely contains an error. A user can point out what is wrong with the solution by playing this video that better understanding for the problem is promoted.

According to the present invention explained above, efficient learning support can be provided using actual homework and assignments from school.

From the aforementioned explanation, those skilled in the art ascertain the essential characteristics of the present invention and can make the various modifications and variations to the present invention to adapt it to various usages and conditions without departing from the spirit and scope of the claims.

What is claimed is:

1. A learning support system which supports learning on a computer comprising: means for reading a question sheet on a computer as an image, means for identifying each problem from the image, means for entering whether correct answer was obtained or not for each problem on the question sheet, and means for identifying components of problems entered as incorrect in the means for entering whether correct answer was obtained or not on a database.

2. A learning support system as recited in claim 1 further comprising: means for displaying problems on the computer by extracting problems which contain the same components as the problems entered as incorrect from the database, and means for answering the problems displayed in the means for displaying problems on the computer.

3. A learning support system as recited in claim 2 further comprising means for playing or displaying solution of the problems displayed in the means for displaying problems on the computer.

4. A learning support system as recited in claim 2 further comprising means for sending learning progress of a user to a terminal of a predetermined person.

5. A learning support system as recited in claim 2 further comprising means for periodically displaying problems which contain the same components as the problems that have been answered incorrectly in the means for answering the problems displayed in the means for displaying problems on the computer in the past.

6. A learning support system as recited in claim 1 further comprising means for automatically generating a reference solution video based on the components of problems entered as incorrect in the means for entering whether correct answer was obtained or not.

7. A learning support system as recited in claim 6 further comprising means for automatically generating a solution video which contains typical errors based on the components of problems entered as incorrect in the means for entering whether correct answer was obtained or not.

8. A method of supporting learning on a computer comprising the steps: reading a question sheet on a computer as an image; identifying each problem from the image; entering whether correct answer was obtained or not for each problem on the question sheet; and identifying components of problems entered as incorrect in the step of entering whether correct answer was obtained or not on a database.

9. A method of supporting learning as recited in claim 8 further comprising the steps: displaying problems on the computer by extracting problems which contain the same components as the problems entered as incorrect from the database; and answering the problems displayed in the step of displaying problems on the computer.

10. A method of supporting learning as recited in claim 9 further comprising the step of playing or displaying solution of the problems displayed in the step of displaying problems on the computer.

11. A method of supporting learning as recited in claim 9 further comprising the step of sending learning progress of a user to a terminal of a predetermined person.

12. A method of supporting learning as recited in claim 9 further comprising the step of periodically displaying problems that have been answered incorrectly in the step of answering the problems displayed in the step of displaying problems on the computer in the past.

13. A method of supporting learning as recited in claim 8 further comprising the step of automatically generating a reference solution video based on the components of problems entered as incorrect in the step of entering whether correct answer was obtained or not.

14. A method of supporting learning as recited in claim 13 further comprising the step of automatically generating a solution video which contains typical errors based on the components of problems entered as incorrect in the step of entering whether correct answer was obtained or not.
